(19) United States
(12) Patent Application Publication
(10) Pub. No.: US 2003/0021431 A1
(43) Pub. Date: Jan. 30, 2003

(54) Acoustic device

(75) Inventors: Neil Harris, Cambridge (GB); Bijan Djahansouzi, Huntingdon (GB); Mark Richard Eccles, Cambridge (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 10/202,631

(22) Filed: Jul. 25, 2002

Related U.S. Application Data
(60) Provisional application No. 60/309,468, filed on Aug. 3, 2001.

(30) Foreign Application Priority Data
Jul. 26, 2001 (GB) 0118206.2

(51) Int. Cl. H04R 25/00

(52) U.S. Cl. 381/152

(57) ABSTRACT

An acoustic device having a panel-form member adapted to support bending wave vibration and having a frequency distribution of resonant bending wave modes. The member is of substantially triangular form with the parameters of the member being selected to provide a desired frequency distribution of resonant modes. At least one of the parameters is selected from the ratio of the effective lengths of two of the sides of the triangular form, the effective angle between at least two of the sides of the triangular form, and the curvature of at least one side.

### CROSS REFERENCE TO RELATED APPLICATIONS

This application claims the benefit of U.S. Provisional Application Serial No. 60/309,468, filed Aug. 3, 2001.

### BACKGROUND

The present invention relates to loudspeakers, in particular loudspeakers of the distributed-mode variety (hereinafter referred to as ‘DM loudspeakers’).

Loudspeakers comprising an acoustic radiator capable of supporting bending waves and a transducer mounted on the acoustic radiator to excite bending waves in the acoustic radiator to produce an acoustic output are described, for example, in WO97/09842 and corresponding U.S. Pat. No. 6,332,029 the latter of which is herein incorporated by reference in its entirety.

The properties of such an acoustic radiator may be chosen to distribute the resonant bending wave modes substantially evenly in frequency. In other words, the properties or parameters, e.g. size, thickness, shape, material etc., of the acoustic radiator may be chosen to smooth peaks in the frequency response caused by “bunching” or clustering of the modes. The resultant distribution of resonant bending wave modes may thus be such that there are substantially minimal clusterings and disparities of spacing.

In particular, the properties of such an acoustic radiator may be chosen to distribute the lower frequency resonant bending wave modes substantially evenly in frequency. The number of resonant bending wave modes is less at lower frequency than at higher frequency and thus the distribution of the lower frequency resonant bending wave modes is particularly important if the loudspeaker is required to have an output extending into this region. The lower frequency resonant bending wave modes are preferably the ten to twenty lowest frequency resonant bending wave modes of the acoustic radiator.

The resonant bending wave modes associated with each conceptual axis of the acoustic radiator may be arranged to be interleaved in frequency. Each conceptual axis has an associated lowest fundamental frequency (conceptual frequency) and higher modes at spaced frequencies. By interleaving the modes associated with each axis, a substantially even distribution may be achieved. There may be two conceptual axes and the axes may be symmetry axes. For example, for a rectangular acoustic radiator, the axes may be a short and a long axis parallel to a short and a long side of the acoustic radiator, respectively.

The transducer location of such loudspeakers is typically chosen to couple substantially evenly to the resonant bending wave modes. In particular, the transducer location may be chosen to couple substantially evenly to lower frequency resonant bending wave modes. In other words, the transducer may be mounted at a location spaced away from nodes (or dead spots) of as many lower frequency resonant modes as possible. Thus the transducer may be at a location where the number of vibrationally active resonance anti-nodes is relatively high and conversely the number of resonance nodes is relatively low.

WO 97/09842 (U.S. Pat. No. 6,332,029) indicates that the panel can have the form of a regular or irregular polygon. Similar arrangements are described in WO 00/28781 and corresponding U.S. patent application Ser. No. 09/435,360, which shows pyramid and tetrahedral speakers that at least partially enclose an air volume so that the bending waves couple to the volume to provide coupled resonant modes.

The present invention has as an objective an improvement in the acoustic performance of such distributed resonant mode bending wave loudspeakers having substantially triangular panels.

### SUMMARY OF THE INVENTION

According to one aspect of the invention, there is provided an acoustic device comprising a panel-form member capable of supporting bending wave vibration and having a frequency distribution of resonant bending wave modes, the member being of substantially three-sided form with the parameters of the member being selected so as to provide a desired frequency distribution of resonant modes, wherein at least one of the parameters is selected from the group consisting of the ratio of the effective lengths of two of the sides of said three-sided form, the effective angle between at least two of the sides of said three-sided form and the curvature of at least one side.

The parameters may be selected alone or in combination to give the desired frequency distribution. For example, the ratio of the effective lengths of two of the sides of the three-sided form which gives the desired distribution may be selected. The effective angle between at least two of the sides may then be varied to see whether further improvement in the frequency distribution may be obtained. Alternatively, the angle may be selected then the sides varied or the curvature selected then the angle varied etc.

The desired frequency distribution may be more uniform than the frequency distribution of a rectangular panel-form member having one side of length equal to one side of the triangle and having an aspect ratio of about 1.134. The aspect ratio 1.134 is the “golden” aspect ratio as taught in WO 97/09842 (U.S. Pat. No. 6,332,029). In other words, the parameters may be selected so that non-uniformity of the frequency distribution of the triangular panel-form member may be reduced compared to that of the rectangular panel-form member.

The parameters may be selected to minimise non-uniformity of the frequency distribution. By minimising non-uniformity, a distribution having resonant bending wave modes substantially evenly distributed in frequency may be achieved. As will be appreciated from the aforementioned WO97/09842 (U.S. Pat. No. 6,332,029), an increase in the uniformity of distribution of the resonant modes that underpin the operation of this genre of device will result in an improvement of the frequency response of the device itself.

The member may be made of a material which is isotropic as to bending stiffness. In this case, the effective lengths and the effective angle are the actual lengths and actual angle. Alternatively, the member may be made of a material which is anisotropic as to bending stiffness. In this case, the effective lengths and the effective angle are the actual lengths and actual angle adjusted to compensate for the anisotropy of the material.

The ratio of the effective lengths may lie in the range of about 1.08:1 to about 1.17:1, of about 1.82:1 to about 1.88:1, or of about 1.42:1 to about 1.49:1. The effective angle may lie in the range about 75 to about 100 degrees.

The member may be in the shape of a truncated triangle, i.e., with two sides of the member are truncated and connected by a fourth side. The effective angle may be defined between the truncated sides. The ratio of the effective lengths of the truncated sides may be selected to provide the desired frequency distribution.

The curvature of each side of the panel-form member may be selected to be zero. In this case, at least one of the other parameters is varied to achieve the desired frequency distribution. The member may have two substantially straight sides and a third curved side; the effective angle being defined between the two substantially straight sides. At least two or all sides may be curved. The, or each, curved side may be convex or concave.

In one embodiment, the third side consists of a first arc of effective radius R centred on a point of intersection of the two straight lines. Such an arrangement has an advantageously uniform distribution of resonant modes giving rise to improved acoustical performance.

The member may be in the shape of a truncated triangle. The truncation may be defined by a second arc of effective radius r centred on the point of intersection. The ratio ρ of the effective radius r of the second arc of to the effective radius R of the first arc may be selected to provide the desired frequency distribution, for example r:R may be about 1:5. The effective angle θ and the ratio ρ may be selected together to give the desired frequency distribution, for example, they may be related according the formula:

θ=95−50ρ.

The panel-form member may be substantially in the form of a right-angled triangle. The right angle may or may not be the effective angle. Additional improvements in the frequency distribution may be achieved by combination of the present invention with other measures such as variation in panel parameters (e.g., mass, stiffness, etc). Such measures may result in improvements in aspects of performance other than distribution of resonant modes, for example a decrease in the lowest operating frequency of the acoustic device, thereby improving the reproduction of bass tones.

A loudspeaker incorporating an acoustic device as hereinbefore described and an exciter mounted thereto to apply bending wave energy to the acoustic device to cause the acoustic device to resonate is also included in the invention. By appropriate selection of the frequency distribution, a desired acoustic output may be achieved. If a substantially uniform distribution is achieved, a substantially uniform performance (acoustic output) with frequency may be expected.

Similarly, a microphone comprising an acoustic device as hereinbefore described and a transducer coupled thereto to produce a signal in response to resonance of the panel-form member due to incident acoustic energy is also included in the invention.

### BRIEF DESCRIPTION OF DRAWINGS

Examples that embody the best mode for carrying out the invention are described in detail below and are diagrammatically illustrated in the accompanying drawings in which:

FIG. 1 is a schematic view of a loudspeaker incorporating an acoustic device according to one aspect of the present invention;

FIG. 2 shows variation in non-uniformity L with variation in the ratio R of the effective lengths of two sides of a panel of the kind shown in FIG. 1;

FIGS. 3A and 3B illustrate the distribution with frequency f of the resonant modes for triangular panels having sides of effective length in the ratio 1.13:1 and 1.85:1, respectively;

FIG. 4 shows variation in non-uniformity L with variation in the ratio R of the effective lengths of two sides of a panel of the kind shown in FIG. 1 mounted by a resilient suspension;

FIGS. 5A and 5B illustrate the distribution with frequency f of the resonant modes for triangular panels having sides of effective length in the ratio 1.13:1 and 1.45:1, respectively;

FIG. 6 is a diagrammatic illustration of the panel of FIG. 1 indicating deviation from 90° of angle E;

FIG. 7 shows variation in resonant frequency distribution L uniformity with effective angle E;

FIGS. 8A, 8B and 8C illustrate the distribution with frequency f of the resonant modes for triangular panels having effective angles of 90°, 85° and 95°, respectively;

FIGS. 9A and 9B are schematic plan views of an acoustic device according to two further aspects of the present invention;

FIG. 10 is a contour plot showing variation in uniformity of distribution of resonant modes with effective ratio ρ and effective angle θ.

FIGS. 11A, 11B and 11C illustrate the distribution with frequency f of the resonant modes for panels of FIG. 9B having effective angles of 45°, 50° and 85°, respectively;

FIG. 11D illustrates the distribution with frequency f of the resonant modes for a panel of FIG. 9B having an effective angle of 70°; and

FIGS. 12A to 12E are plan views of various acoustic devices according to the present invention.

### DETAILED DESCRIPTION

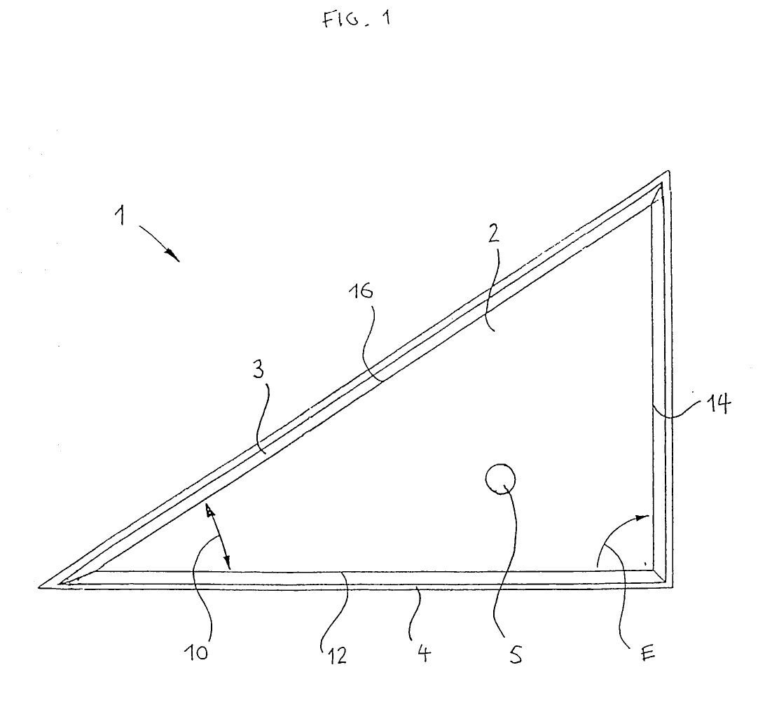

FIG. 1 shows a panel-form loudspeaker 1 comprising a panel-form member 2 and a transducer 5 for exciting the panel to bending wave vibration, thereby to produce an acoustic output. The panel-form member 2 is supported in a frame 4 by a resilient suspension 3. Both the frame 4 and the suspension 3 extend around the periphery of the panel-form member. The panel-form member 2 is capable of supporting bending wave vibration and has a frequency distribution of resonant bending wave modes.

The location of the transducer 5 for exciting the panel-form member to bending wave vibration is chosen to couple substantially evenly to the resonant bending wave modes, particularly to lower frequency resonant bending wave modes. Methods for determining such locations are well known, e.g. from the aforementioned WO97/09842 (U.S. Pat. No. 6,332,029), also WO99/52324 (U.S. patent application Ser. No. 09/280,854) and WO99/56497 (U.S. patent application Ser. No. 09/300,470) all of which are incorporated herein by reference.

In FIG. 1, the panel-form member is in the form of a right-angled (E) triangular panel. The shape of the right-angled triangle is defined by adjacent and opposite sides 12, 14 (i.e., the legs of the triangle) and hypotenuse side 16 and the angle 10 between leg side 12 and hypotenuse side 16. In accordance with a first aspect of the invention, the ratio of the lengths of the adjacent and opposite sides 12, 14 is chosen to give the desired frequency distribution of resonant modes.

In particular, the ratio may be selected so as to minimise non-uniformity in the distribution of the frequencies of resonant modes of bending wave vibration of the member. By minimising non-uniformity there is a greater likelihood of even coupling of the transducer to the resonant modes at any given location. Accordingly, the positioning of the transducer may be less critical. Uniformity of distribution of the frequencies of resonant modes can be expressed by a number of different measures, see for example WO99/56497 (U.S. patent application Ser. No. 09/300,470) of the present applicant. In the following Figures, uniformity is measured by the value L of the least squares central difference of mode frequencies, i.e.:

$$L = \sqrt{{\sum }_{m = 1}^{M - 1} \frac{{( {f}_{m - 1} + {f}_{m + 1} - 2 {f}_{m} )}^{2}}{M - 1}}$$

where fₘ is the frequency of the mth mode (0<=m<=M)

L is preferably normalised so that it is insensitive to variables other than shape. The normalisation may be multiplication by panel area or multiplication by panel area divided by a reference area. If the panels being compared are made from the same material, scaling by area is quite effective. Alternatively, L may be normalised by multiplying by modal density. The mean modal density is defined by the following equation:

$$\frac{ⅆ N}{ⅆ f} = \frac{Area}{2} \sqrt{\frac{μ}{B}}$$

Where N is the number of modes, μ is the areal density of the panel and B is the bending stiffness of the panel material. These normalisation operations are effectively equivalent.

FIG. 2 shows variation in non-uniformity L with variation in the ratio R of the effective lengths of the adjacent and opposite sides of a panel of the kind shown in FIG. 1. The results, obtained from theoretical modelling, assume a suspension 3 having zero stiffness. Line A indicates the level of non-uniformity (approximately 49.939) of a corresponding rectangular panel having an aspect ratio (i.e., a ratio of the longer to the shorter side) of about 1.134. The aspect ratio of the rectangular panel is equal to the ratio of the two sides of the triangle which are not the hypotenuse.

The level of uniformity of the frequency distribution of the triangular panel is as good as, or better, than that of the rectangular panel, i.e., L is equal to or lower than A, for R in the ranges N=1.08 to 1.17 and N′=1.82 to 1.88. Non-uniformity is minimised as shown at M and M′, corresponding to values of R substantially equal to 1.13 and 1.85 respectively.

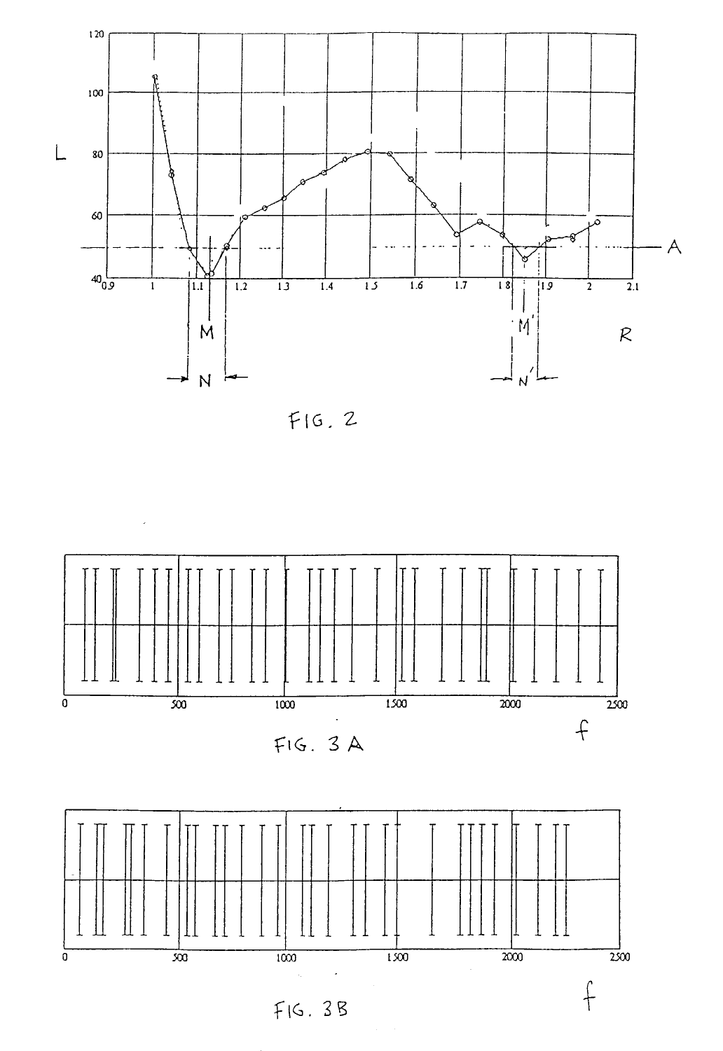

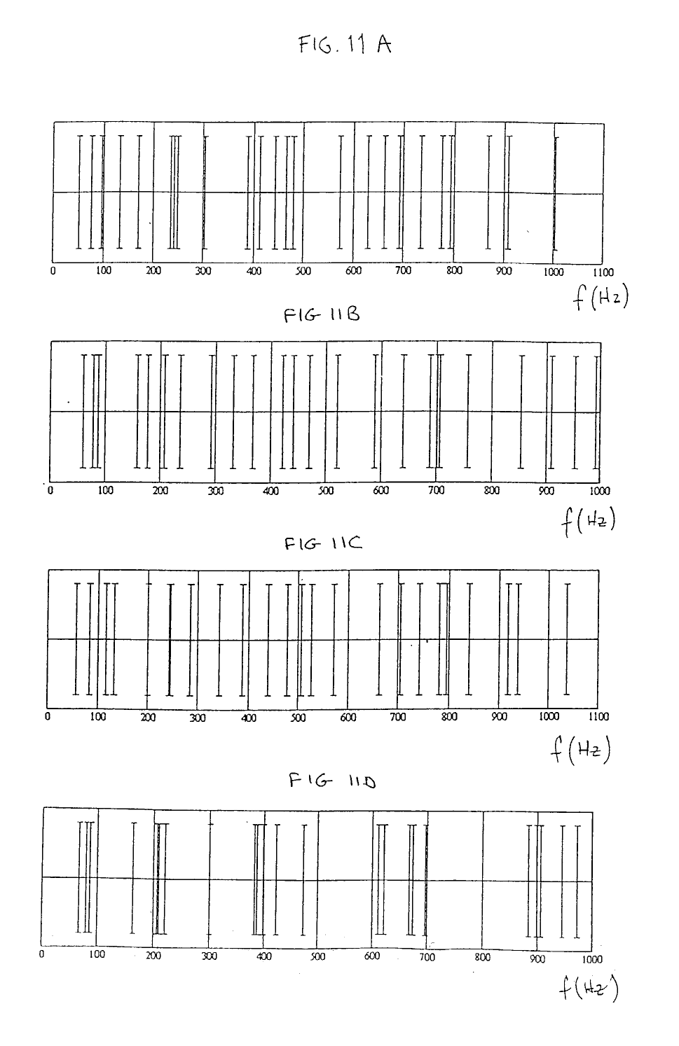

FIGS. 3A and 3B illustrate by means of bars the distribution with frequency f of the resonant modes for triangular panels having adjacent and opposite sides 12,14 in the ratio M=1.13 and M′=1.85 respectively. An example of a low uniformity distribution is shown in FIG. 11D. The frequency distributions of FIGS. 3A and 3B are clearly more uniform than that of FIG. 11D. In FIGS. 3A and 3B, the resonant modes are substantially evenly distributed in frequency, i.e., the modes are approximately equidistantly spaced along the distribution.

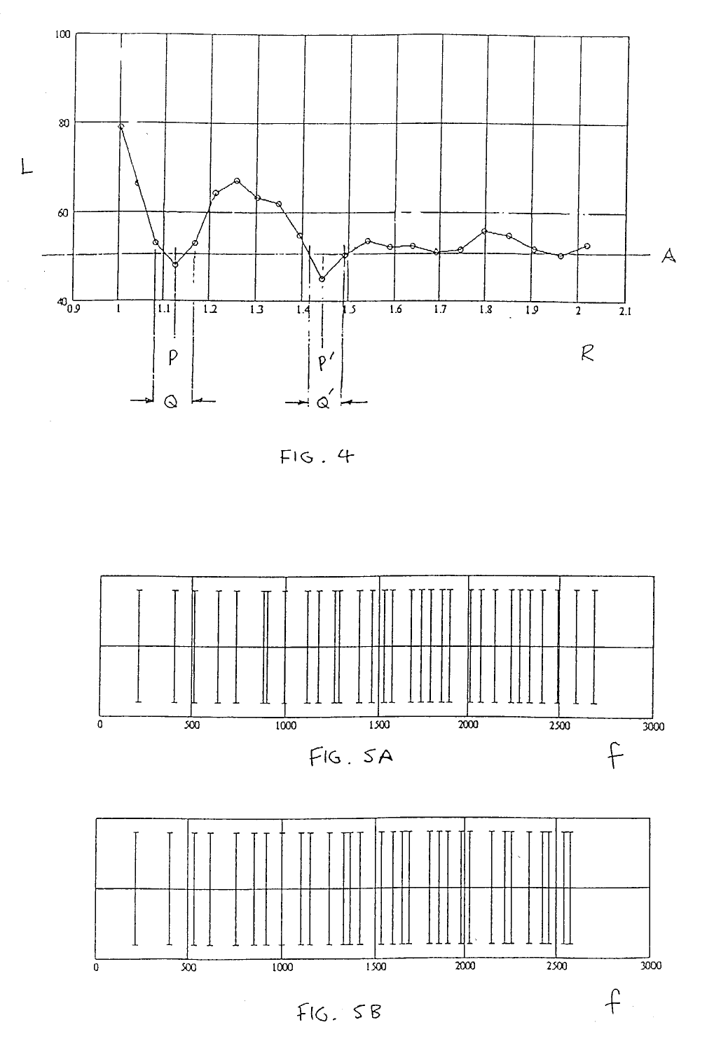

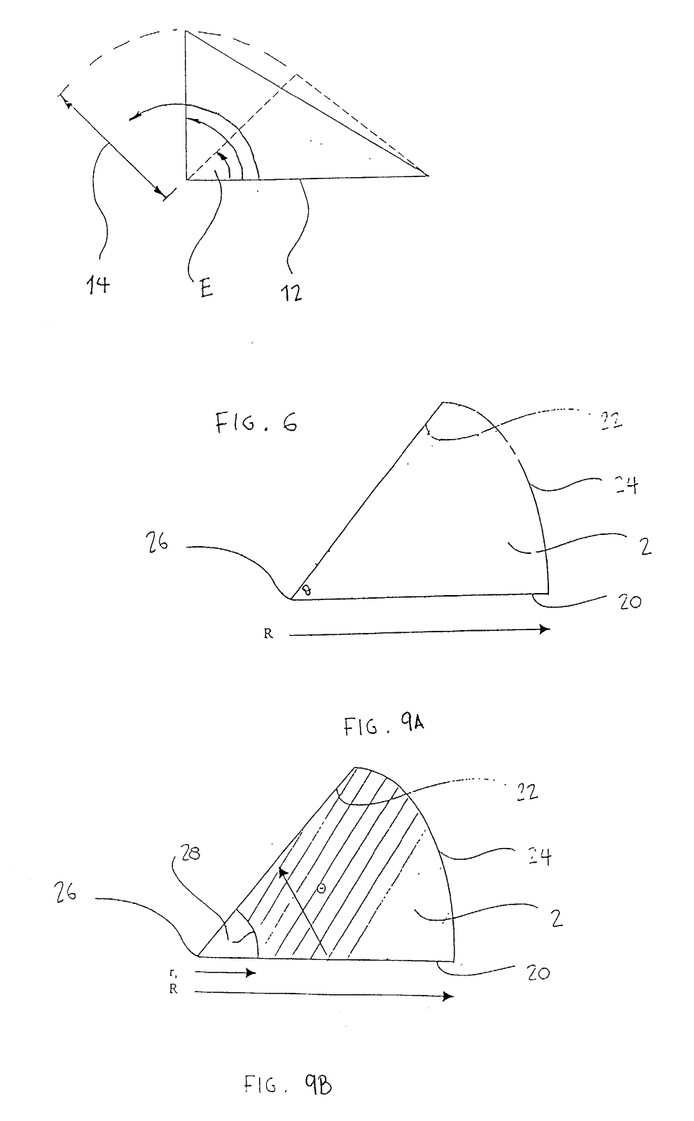

In practical applications, the panel suspension 3 will have a stiffness, typically in the region of 500 kN/m. The panel suspension may be modelled by adding, at each edge node, springs which have a value of 500 kN/m and which constrain only out-of-plane motion. Theoretical results for the variation in non-uniformity of the frequency distribution for such a panel are shown in FIG. 4.

As shown in FIG. 4, non-uniformity L has a first minimum, P, corresponding to R substantially equal to 1.13. However, at approximately L=47, this minimum value is not as low as the corresponding minimum value L=40 of the zero stiffness embodiment. Equal or better performance than a corresponding rectangular panel is obtained over a slightly narrower range of R than that of FIG. 2, namely Q=about 1.11 to about 1.15.

There is a second range, Q′ with R lying between 1.42 to 1.49 in which non-uniformity is less than or equal to that of the corresponding rectangular panel. Non-uniformity is minimised at P′, with L approximately equal to 45 and R substantially equal to 1.45. Both range Q′ and minimum value P′ are lower than the corresponding values for the zero stiffness embodiment of FIG. 2.

Resonant frequency distributions for triangular panels according to the two minima P, P′ are shown in FIGS. 5A and 5B. Again, these can usefully be compared with the low uniformity distribution of FIG. 11D.

Deviation from 90° of angle E of the triangular panel 2 of FIG. 1 can influence uniformity of distribution of resonant modes. As shown in FIG. 6, the angle E between two sides 12, 14 is varied whilst keeping the lengths of the sides constant. The non-uniformity of the frequency distribution is measured, as before, using the least squares parameter L. FIG. 7 shows the variation in non-uniformity L for triangles having various angles E. However, the values of L are nominal and not comparable with those of earlier Figures.

FIG. 7 shows that by appropriate choice of angle E, a desired uniformity of frequency distribution is obtainable. In particular, non-uniformity may be minimised by selecting angle E to be approximately 85 degrees. Similarly low values of non-uniformity may be obtained in the ‘trough’ spanning 75 to 100 degrees as L is almost insensitive to angle in this range. A triangular panel having an effective angle E of 90 degrees (i.e., a right-angle as shown in FIG. 1) has the further advantage of being amenable to fabrication from rectangular stock with little or no waste.

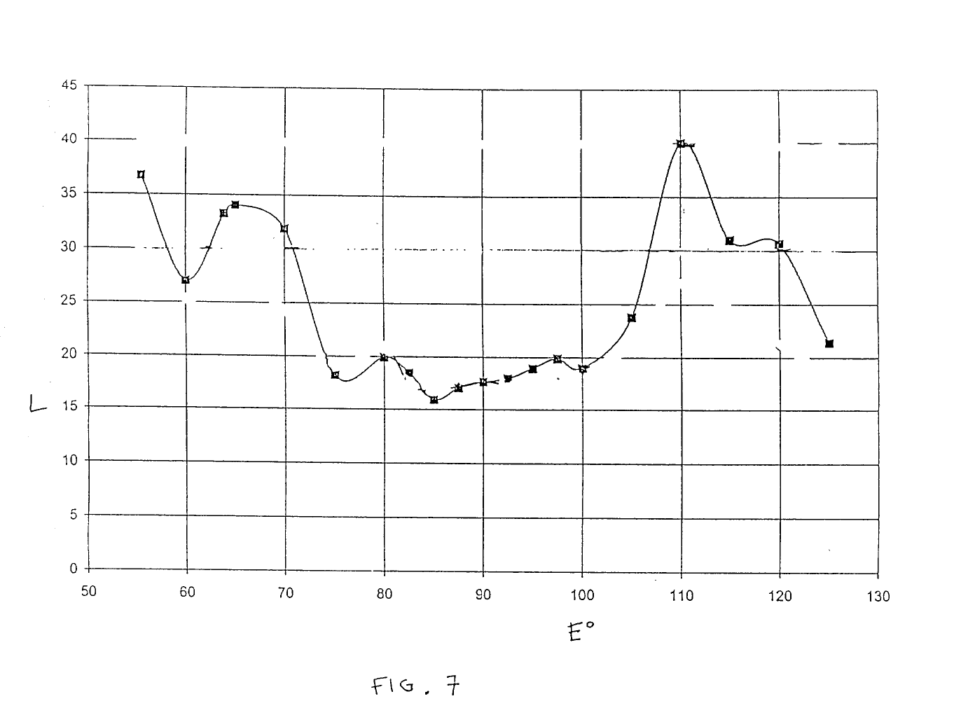

Resonant frequency distributions (in arbitrary frequency units for comparison only) for triangular panels having angle E of 90, 85 and 95 degrees are shown in FIGS. 8A, 8B and 8C respectively. In each Figure, the resonant bending wave modes are substantially evenly distributed in frequency.

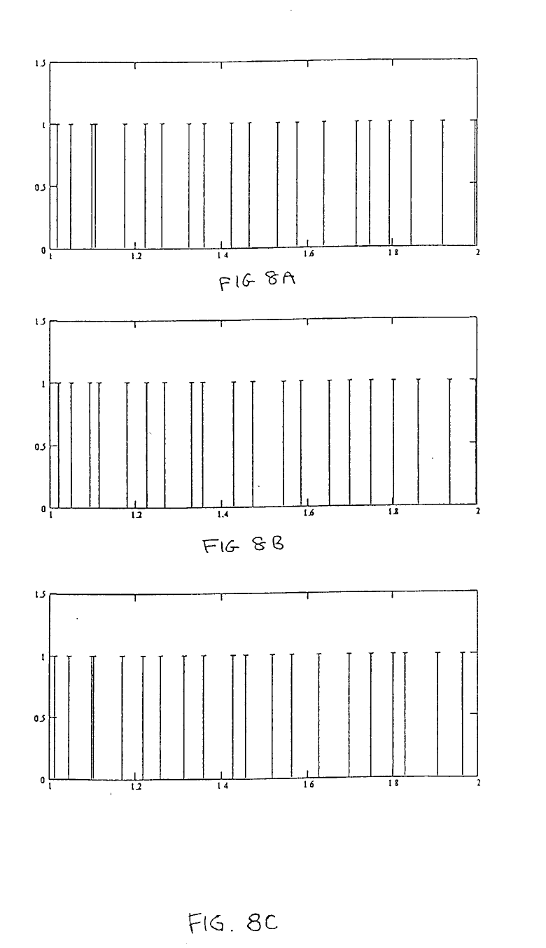

FIG. 9A is a diagrammatic illustration of an acoustic device comprising a substantially triangular panel 2 in the form of a sector. The panel 2 comprises two substantially straight sides 20,22 each of length R and defining an angle θ therebetween and a third curved side 24. The curved side is convexly curved and is defined by an arc of radius R centred on the point of intersection 26 of the two substantially straight sides.

FIG. 9B shows an acoustic device which is generally similar to that of FIG. 9A and thus features in common have the same reference number. The acoustic device comprises a truncated triangular panel 2. The shape is similar to that of the panel of FIG. 9a with a tip section removed. The truncation (or tip section) is defined by a second arc 28 of effective radius r centred on the point of intersection 26. The ratio ρ=r/R has been found to be determinative in resulting acoustic performance of the device. In a preferred embodiment, the outer radius r of said central sector 28 is approximately 5 times smaller than the radius R of said arc 24, i.e. p=0.2.

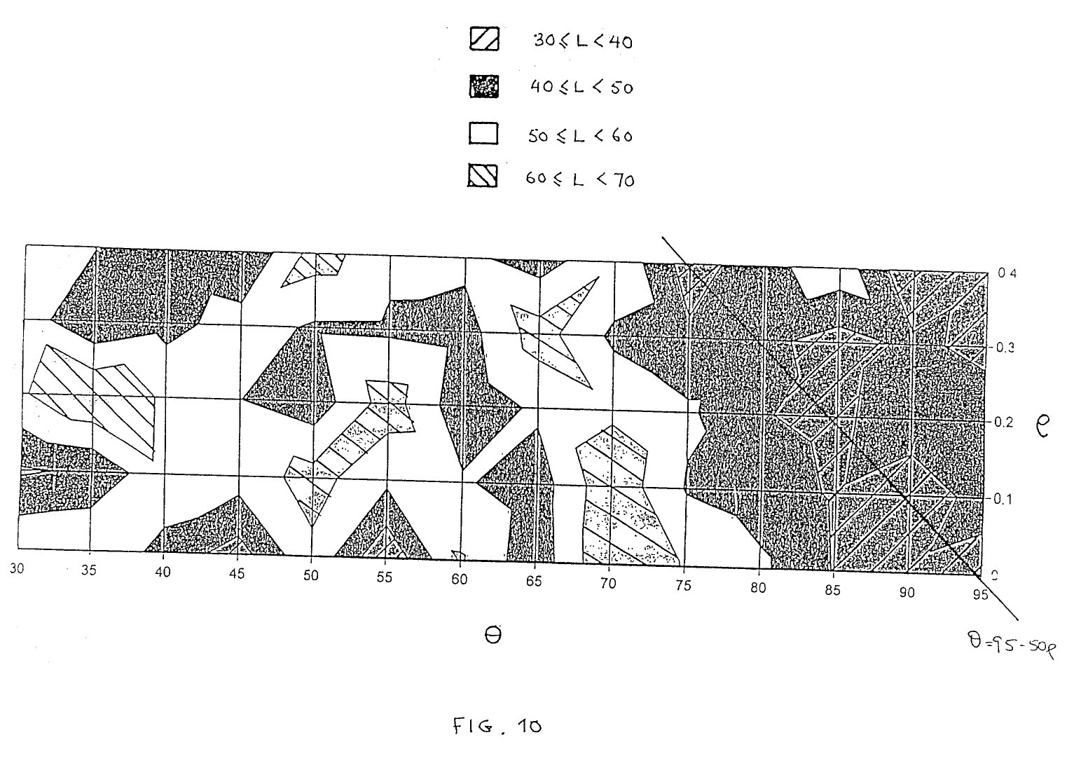

In addition to selecting an appropriate value of ρ, the angle θ between the two substantially straight sides can be chosen so as to give the desired frequency distribution. FIG. 10 shows the variation in non-uniformity L of distribution of resonant modes with both ratio ρ and included angle θ. As before, L is measured by the least squares central difference of mode frequencies and zero stiffness suspension was assumed for the purposes of modelling.

The parameter values may be selected to give a frequency distribution which is more uniform that than of a rectangular panel having equal area to the embodiment of FIG. 9A and an aspect ratio of about 1.134. Thus, the parameter values may be selected to give a value of L less than about 47. For the embodiment of FIG. 9A, ρ=0.1 and L is minimised for θ approximately equal to 45, 55 and 85 to 90 degrees. For the preferred embodiment of FIG. 9B, ρ=0.2 and L is minimised for θ in the range 81 to 86 degrees. In general, the minimum values of L substantially follow the trend line θ=95−50ρ.

Resonant frequency distributions for panels of FIG. 9A having angles of 45, 55 and 85 to 90 degrees are shown in FIGS. 11A, 11B and 11C, respectively. For comparison, FIG. 11D shows a low uniformity distribution for a panel having θ=70° and ρ=0.1. As shown in FIG. 10, such a panel has a value of L greater than 60. The frequency distribution of FIG. 11D is not even with several clusters of modes at approximately 200 Hz, 400 Hz, etc. In contrast, the frequency distributions of FIGS. 11A, 11B and 11C are substantially even.

The above examples relate to isotropic panel materials in which the effective lengths and angles correspond to the actual lengths and angles of the panel. Where the panel material is anisotropic or, more particularly, orthotropic (having two orthogonal axes of stiffness), the actual lengths and angles of the panel differ from the effective lengths and angles as a result of the orientation dependent stiffness of the material. Calculation of the actual dimensions of a panel first involves establishing the difference between the orthogonal directions of stiffness of the orthotropic material and the principal orientations of the nodal lines of an equivalent isotropic panel (calculated using, for example, Finite Element Analysis). Thereafter, the directions of stiffness of the orthotropic material are resolved onto the principal orientations of the nodal lines. The ratios of stiffnesses resolved in each direction to the stiffness of an isotropic panel in each direction are then used to compensate the dimensions of the panel in the same directions thereby arriving at actual panel dimensions that provide the necessary uniformity of frequency distribution. The following relationship is used in the compensation:

B/X⁴=constant

Where B is the bending stiffness of the panel along each direction and X is the actual length of the panel. Consider the following example:

A panel having actual lengths L1 and L2 is made of an orthotropic material having bending stiffnesses B1 and B2 in the orthogonal directions of stiffness. The effective lengths L1′ and L2′ of a panel made of an isotropic material having bending stiffness B3 are calculated as follows:

1. The directions of stiffness of the orthotropic material are resolved onto the principal orientations of the nodal lines to give bending stiffnesses B1′ and B2′.

2. Assuming B1/B3=16 and B2/B3=1, the relationship B/X⁴=constant is applied. Thus, 2L1′=L1 and L2=L2. In other words, the effective lengths of the two sides L1 and L2′ are half the actual length L1 and the actual length L2 of the two corresponding sides.

The principal orientations of the nodal lines are known as the conceptual axes. The conceptual frequencies are the frequencies of beams which are of equal length to the conceptual axes. The compensation relationship is derived from the equation for the resonance frequency fₙ of a mode in a beam, namely:

$${f}_{n} = {( \frac{{λ}_{n}}{X} )}^{2} \sqrt{\frac{B}{μ}}$$

where B is the bending rigidity, μ is the areal density, X is the beam length, and λ is a constant, which depends upon the mode number and the units used for the other parameters. The frequency of a mode that is related to a particular conceptual axis is thus proportional to the square root of bending stiffness along that axis and inversely proportional to the actual length along that axis.

For an orthotropic panel μ is fixed and B has value B1 along one axis and B2 along a perpendicular axis. The axes equate to beams of length L1 and L2, respectively. The interleaving of the modes along the two axes is important; the aim is to keep the ratio of the frequencies of each axis constant. By rearranging the equation below (i.e., the ratio of the frequencies) we arrive at the compensation relationship:

$$\frac{f1}{f2} = {( \frac{L2}{L1} )}^{2} \sqrt{\frac{B1}{B2}} = C$$

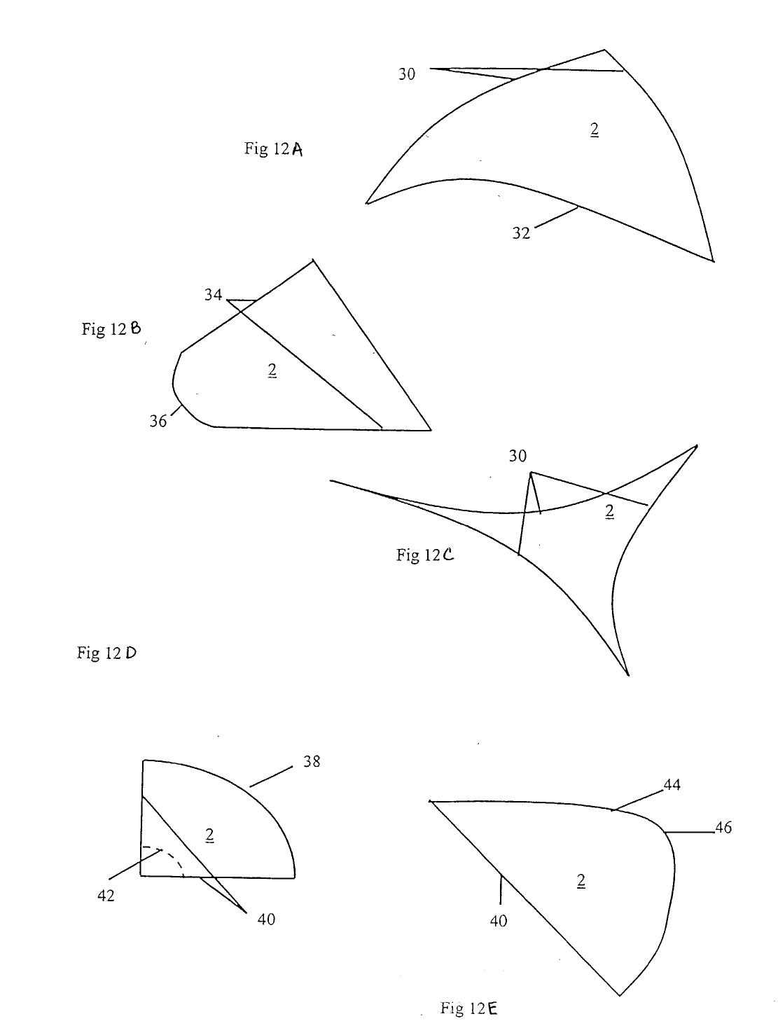

FIGS. 12A to 12E show a variety of panel shapes. In FIGS. 12A and 12C, all three sides of the panel 2 are curved. In FIG. 12A two sides 30 are convex curves and one side 32 is a concave curve so that the panel has a sail-like shape. In FIG. 12C, three sides 33 are concave curves so that the panel has epicycloidal geometry. In FIG. 12B, the panel 2 is in the form of a truncated triangle with the truncated sides 34 connected by a concave curve 36; the concave curve 36 thus defines the truncation. In FIG. 12D, the panel 2 is generally similar to that of FIGS. 9A and 9B except that the curved side 38 is defined by an ellipse having its centre at the point of intersection of the two straight sides 40. The panel 2 may or may not be truncated with the dotted line 42 defining the optional truncation. The dotted line 42 is also an ellipse having its centre at the point of intersection. In FIG. 12E, the panel has a single straight side 40, the two other sides are curved so as to form a continuous parabolic curve 44 with a cusp or rounded point 46.

It should be understood that this invention has been described by way of examples only and that a wide variety of modifications can be made without departing from the scope of the invention as described in the accompanying claims.

1. Acoustic device comprising:
a panel-form member adapted to support bending wave vibration and having a frequency distribution of resonant bending wave modes,
wherein the member is of substantially three-sided form with parameters of the member being selected to provide a desired frequency distribution of resonant modes, wherein at least one of the parameters is selected from the group consisting of the ratio of the effective lengths of two of the sides of said three-sided form, the effective angle θ between at least two of the sides of said three-sided form, and the curvature of at least one side.

2. Acoustic device according to claim 1, wherein the parameters are selected so as to minimise non-uniformity in the frequency distribution.

3. Acoustic device according to claim 1, wherein the member is made of a material which is isotropic as to bending stiffness, and wherein the effective lengths and the effective angle are the actual lengths and actual angle.

4. Acoustic device according to claim 1, wherein the member is made of a material which is anisotropic as to bending stiffness, and wherein the effective lengths and the effective angle are the actual lengths and actual angle adjusted to compensate for the anisotropy of the material.

5. Acoustic device according to claim 1, wherein said ratio of the effective lengths lies in the range of about 1.08:1 to about 1.17:1.

6. Acoustic device according to claim 5, wherein said ratio lies in the range of about 1.11:1 to about 1.15:1.

7. Acoustic device according to claim 6, wherein said ratio substantially equals 1.13:1.

8. Acoustic device according to claim 5, wherein the member is made of a material which is isotropic as to bending stiffness, and wherein the effective lengths and the effective angle are the actual lengths and actual angle.

9. Acoustic device according to claim 5, wherein the member is made of a material which is anisotropic as to bending stiffness, and wherein the effective lengths and the effective angle are the actual lengths and actual angle adjusted to compensate for the anisotropy of the material.

10. Acoustic device according to claim 1, wherein said ratio of the effective lengths lies in the range of about 1.82:1 to about 1.88:1.

11. Acoustic device according to claim 10, wherein said ratio substantially equals 1.85:1.

12. Acoustic device according to claim 10, wherein the member is made of a material which is isotropic as to bending stiffness, and wherein the effective lengths and the effective angle are the actual lengths and actual angle.

13. Acoustic device according to claim 10, wherein the member is made of a material which is anisotropic as to bending stiffness, and wherein the effective lengths and the effective angle are the actual lengths and actual angle adjusted to compensate for the anisotropy of the material.

14. Acoustic device according to claim 1, wherein said ratio of the effective lengths lies in the range of about 1.42:1 to about 1.49:1.

15. Acoustic device according to claim 14, wherein said ratio substantially equals 1.45:1.

16. Acoustic device according to claim 14, wherein the member is made of a material which is isotropic as to bending stiffness, and wherein the effective lengths and the effective angle are the actual lengths and actual angle.

17. Acoustic device according to claim 14, wherein the member is made of a material which is anisotropic as to bending stiffness, and wherein the effective lengths and the effective angle are the actual lengths and actual angle adjusted to compensate for the anisotropy of the material.

18. Acoustic device according to claim 1, wherein said effective angle lies in the range about 75 to about 100 degrees.

19. Acoustic device according to claim 18, wherein said effective angle is substantially 85 degrees.

20. Acoustic device according to claim 18, wherein said effective angle is substantially 90 degrees.

21. Acoustic device according to claim 18, wherein said ratio of the effective lengths lies in the range about 1.08:1 to about 1.17:1.

22. Acoustic device according to claim 18, wherein said ratio of the effective lengths lies in the range of about 1.82:1 to about 1.88:1.

23. Acoustic device according to claim 18, wherein said ratio of the effective lengths lies in the range of about 1.42:1 to about 1.49:1.

24. Acoustic device according to claim 1, wherein the member is in the form of a truncated triangle.

25. Acoustic device according to claim 1, wherein each side of the member is curved.

26. Acoustic device according to claim 1, wherein the member has two substantially straight sides and a third curved side, and wherein the effective angle is defined between the two substantially straight sides.

27. Acoustic device according to claim 26, wherein said effective angle is substantially 45, 54, 90, or 95 degrees.

28. Acoustic device according to claim 26, wherein the third side consists of a first arc of effective radius R centred on a point of intersection of the two straight lines.

29. Acoustic device according to claim 28, wherein the member is shaped as a truncated triangle.

30. Acoustic device according to claim 29, wherein the truncation is defined by a second arc of effective radius r centred on the point of intersection.

31. Acoustic device according to claim 30, wherein the ratio ρ of the effective radius r to the effective radius R is selected to provide the desired frequency distribution.

32. Acoustic device according to claim 31, wherein the effective radius r is approximately 5 times smaller than the effective radius R.

33. Acoustic device according to claim 31, wherein the effective angle θ and the ratio ρ substantially follow the relationship θ=95−50ρ.

34. An acoustic device comprising:
a panel-form member adapted to support bending wave vibration and having a frequency distribution of resonant bending wave modes, the member being of substantially three-sided form and comprising:
two substantially straight sides,
a third curved side; and
an effective angle θ defined between the two substantially straight sides.

35. Acoustic device according to claim 34, wherein the effective angle θ is selected to minimise non-uniformity in the frequency distribution.

36. Acoustic device according to claim 34, wherein the third side consists of a first arc of effective radius R centred on a point of intersection of the two straight sides.

37. Acoustic device according to claim 36, wherein the member is shaped as a truncated triangle, and wherein the truncation is defined by a second arc of effective radius r centred on the point of intersection.

38. Acoustic device according to claim 37, wherein a ratio ρ of the effective radius r to the effective radius R is selected to provide the desired frequency distribution.

39. A loudspeaker comprising:
an acoustic device comprising:
a panel-form member adapted to support bending wave vibration and having a frequency distribution of resonant bending wave modes, wherein the member is of substantially three-sided form with parameters of the member being selected to provide a desired frequency distribution of resonant modes, wherein at least one of the parameters is selected from the group consisting of the ratio of the effective lengths of two of the sides of said three-sided form, the effective angle between at least two of the sides of said three-sided form, and the curvature of at least one side; and
a transducer coupled to the panel-form member to apply bending wave energy thereto to cause the panel-form member to resonate to produce an acoustic output.

40. Loudspeaker according to claim 39, wherein the parameters are selected to minimise non-uniformity in the frequency distribution.

41. A microphone comprising:
an acoustic device comprising:
a panel-form member adapted to support bending wave vibration and having a frequency distribution of resonant bending wave modes, wherein the member is of substantially three-sided form with parameters of the member being selected to provide a desired frequency distribution of resonant modes, wherein at least one of the parameters is selected from the group consisting of the ratio of the effective lengths of two of the sides of said three-sided form, the effective angle between at least two of the sides of said three-sided form, and the curvature of at least one side; and
a transducer coupled to the panel-form member to produce a signal in response to resonance of the panel-form member due to incident acoustic energy.
